(19) United States
(12) Patent Application Publication
(10) Pub. No.: US 2014/0365334 A1
(43) Pub. Date: Dec. 11, 2014

(54) RETAIL CUSTOMER SERVICE INTERACTION SYSTEM AND METHOD

(71) Applicant: Matthew Hurewitz, Hemet, CA (US)

(72) Inventor: Matthew Hurewitz, Hemet, CA (US)

(73) Assignee: BBY SOLUTIONS, INC., Richfield, MN (US)

(21) Appl. No.: 14/180,484

(22) Filed: Feb. 14, 2014

Related U.S. Application Data
(63) Continuation-in-part of application No. 14/031,113, filed on Sep. 19, 2013.
Application No. 14/031,113 is a continuation-in-part of application No. 13/912,784, filed on Jun. 7, 2013.

(51) Int. Cl. G06Q 30/06

(52) U.S. Cl. CPC G06Q 30/0613
USPC 705/26.41

(57) ABSTRACT

A system is provided that monitors a customer's movements, locations, product interactions, and purchase behavior within a physical retail store. Emotional reactions to physical items and the virtual display are also tracked. The customer can utilize a mobile device app to request assistance from a retail store clerk. The app determines the position of the customer's mobile device within the store, such as by using Bluetooth beacons, and then transmits this position and a request for assistance to a server computer. The server gathers information about the customer, and then transmits the information along with the request for assistance and the customer location to a sales clerk. A mobile device used by the clerk receives this information and displays the information and request to the sales clerk.

### RELATED APPLICATIONS

The present application is a continuation-in-part application of U.S. patent application Ser. No. 14/031,113 filed on Sep. 19, 2013, which is itself a continuation-in-part application of U.S. patent application Ser. No. 13/912,784 filed on Jun. 7, 2013.

### FIELD OF THE INVENTION

The present application relates to the field of tracking customer behavior in a retail environment. More particularly, the described embodiments relate to a system and method for tracking customer behavior in a retail store, combining such data with data obtained from customer behavior in an online environment, and presenting such combined data to a retail store employee in a real-time interaction with the customer.

### SUMMARY

One embodiment of the present invention tracks customer movement and product interaction within a physical retail store. A plurality of sensors are used to track customer location and movement in the store. The sensors can identify customer interaction with a particular product, and in some embodiments can register the emotional reactions of the customer during the product interaction. The sensors may be capable of independently identifying the customer as a known customer in the retail store customer database. Alternatively, the sensors may be capable of tracking the same customer across multiple store visits without linking the customer to the customer database through the use of an anonymous profile. The anonymous profile can be linked to the customer database at a later time through a self-identifying act occurring within the retail store. This act is identified by time and location within the store in order to match the self-identifying act to the anonymous profile. The sensors can distinguish between customers using visual data, such as facial recognition or joint position and kinetics analysis. Alternatively, the sensors can distinguish between customers by analyzing digital signals received from objects carried by the customers.

Another embodiment of the present invention uses smart, wearable devices to provide customer information to store employees. An example of a smart wearable device is smart eyewear. An employee can face a customer and request identification of that customer. The location and view direction of the employee is then used to match that customer to a profile being maintained by the sensors monitoring the movement of the customer within the retail store. Once the customer is matched to a profile, information about the customer's current visit is downloaded to the smart wearable device. If the profile is matched to a customer record, data from previous customer interactions with the retailer can also be downloaded to the wearable device, including major past purchases and status in a retailer loyalty program.

In another embodiment, the customer utilizes an app running on a mobile device to request assistance when the customer is within a physical store environment. The app is able to use audible or Bluetooth beacons to identify the customer's location as being within a particular store. In some embodiments, the app identifies the customer's exact location within the store. When the customer desires assistance, their mobile device will send a request to a server device, which in turns send an assistance request to one or more available sales clerks within the store. Once a sales clerk has accepted the request, the server will transmit customer information to the sales clerk, which is then displayed on a mobile device utilized by the clerk. This information can include customer identifying information, the customer's current location within the store, past purchases made with retailer, past customer browsing behavior, the customer's current status in a loyalty program, and any current discounts or promotions that may be available for this customer.

### BRIEF DESCRIPTION OF THE DRAWINGS

FIG. 1 is a schematic diagram of a physical retail store system for analyzing customer shopping patterns and identifying a customer location.

FIG. 2 is a schematic diagram of a system for tracking in-store and online customer behavior and providing in-store assistance to customers.

FIG. 3 is a schematic of a computer operating as a server.

FIG. 4 is a schematic diagram of a store sensor server.

FIG. 5 is a perspective view of smart eyewear that may be used by a store clerk.

FIG. 6 is a schematic view of the view seen by a store clerk using the smart eyewear while interacting with a customer.

FIG. 7 is a flow chart demonstrating a method for collecting customer data analytics for in-store customers.

FIG. 8 is a schematic diagram of customer data available through the system of FIG. 1.

FIG. 9 is a flow chart of a method for downloading customer data to smart eyewear worn by a retail employee.

FIG. 10 is a flow chart demonstrating a method for requesting that a store clerk assist a customer.

FIG. 11 is a system diagram showing the primary components used in the method of FIG. 10.

### DETAILED DESCRIPTION

Retail Store System 100

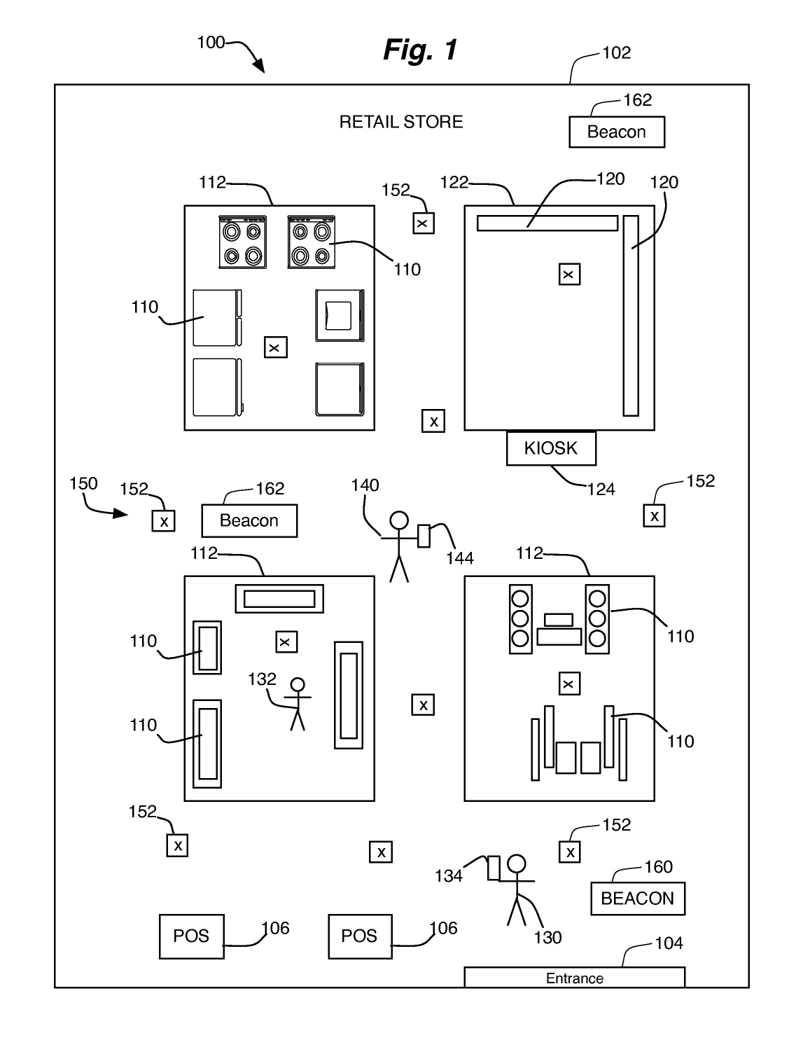

FIG. 1 shows a retail store system 100 including a retail space (i.e., a retail “store”) 102 having both physical retail products 110 and virtual interactive product displays 120. The virtual display 120 allows a retailer to present an increased assortment of products for sale without increasing the footprint of retail space 102. In one embodiment, the retail space 102 will be divided into one or more physical product display floor-spaces 112 for displaying the physical retail products 110 for sale and a virtual display floor-space 122 dedicated to the virtual display 120. In other embodiments, the physical products 110 and virtual displays 120 will be intermixed throughout the retail space 102. The virtual display 120 and its associated kiosk 124 are described in more detail in the incorporated parent patent application Ser. Nos. 14/031,113 and 13/912,784.

Customers 130, 132 may enter the retail store 102 through an entrance 104. The customers 130, 132 may browse the physical merchandise 110 and utilize the virtual displays 120 to select products. A plurality of point-of-sale (POS) terminals 106 within retail store 102 allows customers 130, 132 to purchase physical retail products 110 or order products that the customers 130, 132 viewed on the virtual display 120.

A sales clerk 140 may help customers 130, 132 with purchasing physical products 110 and assisting with use of the virtual display 120. In FIG. 1, customer 130 and sales clerk 140 are shown using mobile devices 134 and 144, respectively. The mobile devices 134, 144 may be tablet computers, smartphones, portable media players, laptop computers, or wearable “smart” fashion accessories such as smart watches or smart eyewear. The smart eyewear may be, for example, Google Glass, provided by Google Inc. of Menlo Park, Calif. The sales clerk 140 may use mobile device 144 to improve their interaction with customers 130, 132.

The retail store system 100 also includes a customer follow-along system 150 to track customer movement within the retail space 102 and to monitor customer interaction with the physical retail products 110 and the virtual display 120. The customer follow-along system 150 is useful to retailers who wish to understand the traffic patterns of customers 130, 132 around the floor of the retail store 102. To implement the tracking system, the retail space 102 is provided with a plurality of sensors 152 (indicated by boxes containing an “x” in FIG. 1). The sensors 152 are provided to detect customers 130, 132 as they visit different parts of the store 102. Each sensor 152 is located at a defined location within the physical store 102, and each sensor 152 is able to track the movement of an individual customer, such as customer 130, throughout the store 102.

In the embodiment shown in FIG. 1, the sensors 152 each have a localized sensing zone in which the sensor 152 can detect the presence of customer 130. If the customer 130 moves out of the sensing zone of one sensor 152, the customer 130 will enter the sensing zone of another sensor 152. The system 150 keeps track of the location of customers 130-132 across all sensors 152 within the store 102. In one embodiment, the sensing zones of all of the sensors 152 overlap so that customers 130, 132 can be followed continuously. In an alternative embodiment, the sensing zones for the sensors 152 may not overlap. In this alternative embodiment the customers 130, 132 are detected and tracked only intermittently while moving throughout the store 102.

Sensors 152 may take the form of visual or infrared cameras that view different areas of the retail store space 102. Computers analyze those images to locate individual customers 130, 132. Sophisticated algorithms on those computers distinguish between individual customers 130, 132, using techniques such as facial recognition. Motion sensors could also be used that do not create detailed images but track the movement of the human body. Computers analyzing these motion sensors can track the skeletal joints of individuals to uniquely identify one customer 130 from all other customers 132 in the retail store 102. In general, the system 150 tracks the individual 132 based on the physical characteristics of the individual 132 as detected by the sensors 152 and analyzed by system computers. The sensors 152 could be overhead, or in the floor of the retail store 102.

In other embodiments, the sensors 152 detect signals from the mobile devices 134 carried by a customer 130. For example, many mobile devices 134 emit a Wi-Fi signal to detect Wi-Fi networks. This signal contains the device's unique MAC address (the “media access control” address). This signal can be used within the retail store environment 102 to identify and locate a customer's mobile device 134 even if the device 134 does not sign onto the Wi-Fi network. Assuming multiple sensors 152 detect the device 134, a relatively precise location for that device 134 within the store 102 can be calculated using well-known triangulation techniques. This device 134 can then be associated with a customer 130 when the customer identifies themselves at the POS 106 or the virtual display 120. Sensors 152 capable of locating a device within an interior space via the MAC address transmitted by the device are available for purchase from a variety of sources including Navicon (Miami, Fla.).

As an example, a customer 130 may walk into the retail store 102 and be detected by a first sensor 152 near the store's entrance 104. The particular customer 130's identity at that point is anonymous, which means that the system 150 cannot associate this customer 130 with identifying information such as the individual's name or a customer ID in a customer database. Nonetheless, the first sensor 152 may be able to identify unique characteristics about this customer 130, such as the MAC address of their device 134, or the customer's facial characteristics or skeletal joint locations and kinetics. As the customer 130 moves about the retail store 102, the customer 130 leaves the sensing zone of the first sensor 152 and enters a sensing zone of a second sensor 152. Each sensor 152 that detects the customer 130 provides information about the path that the customer 130 followed throughout the store 102. Although different sensors 152 are detecting the customer 130, computers can track the customer 130 moving from sensor 152 to sensor 152 to ensure that the data from the multiple sensors are associated with a single individual.

Location data for the customer 130 from each sensor is aggregated to determine the path that the customer 130 took through the store 102. The system 150 may also track which physical products 110 the customer 130 viewed, how long the customer 130 looks at a particular item, and which products were viewed as images on a virtual display 120. A heat map of store shopping interactions can be provided for a single customer 130, or for many customers 130, 132. The heat maps can be strategically used to decide where to place physical products 110 on the retail floor, and which products should be displayed most prominently for optimal sales.

If the customer 130 leaves the store 102 without self-identifying or making a purchase, and if the sensors 152 were unable to independently associate the customer 130 with a known customer in the store's customer database, the tracking data for that customer 130 may be stored and analyzed as anonymous tracking data (or an “anonymous profile”). When the same customer 130 returns to the store, it may be that the sensors 152 and the sensor analysis computers can identify the customer 130 as the same customer tracked during the previous visit. With this ability, it is possible to track the same customer 130 through multiple visits even if the customer 130 has not been associated with personal identifying information (e.g., their name, address, or customer ID number).

If during a later visit the customer 130 chooses to self-identify at any point in the store 102, the customer 130's previous movements around the store can be retroactively associated with the customer 130. For example, if a customer 130 enters the store 102 and is tracked by sensors 152 within the store, the tracking information is initially anonymous. However, if during a subsequent visit (or later during the same visit) the customer 130 chooses to self-identify, for example by entering a customer ID into the virtual display 120, or providing a loyalty card number when making a purchase at POS 106, the previously anonymous tracking data can be assigned to that customer ID. Information, including which stores 102 the customer 130 visited and which products 110 the customer 130 viewed, can be used with the described methods to provide customized deals, rewards, and incentives to the customer 130 to personalize the customer 130's retail shopping experience.

Sensors 152 located near the physical products 110 or the virtual display 120 can track and record the customer's emotional reaction to the physical products 110 and the products displayed on the virtual display. Because the customer's location within the retail store 102 is known by the sensor's 170, emotional reactions can be tied to physical products 110 that are found at that location and are being viewed by the customer 130. One or more sensors 152 identify the product 110 that the customer 132 was interacting with, and detect the customer 132's anatomical parameters such as skeletal joint movement or facial expression. In this way, product interaction data would be collected for the physical products 110, and the interaction data would be aggregated and used to determine the emotions of the customer 130.

In addition to the customer follow-along system 150, the retail store 102 also utilizes a beacon device 160 near the store's entrance 104. This beacon device emits a signal that is detected by the customer's mobile device 134 when they enter the store. The beacon 160 may take the form of a sound emitting device that emits a tone that is inaudible to humans but may be detected by the microphone embedded into the user's mobile device 134. An app running on the mobile device 134 monitors the microphone and interprets the received sound to identify that the user has just entered this store location 102.

Alternatively, the beacon 160 may emit an electromagnetic signal that can be received and interpreted by an antenna found on that device 134. In one embodiment, the beacon emits a Bluetooth signal, such as a Bluetooth Low Energy (or BLE) signal, that is detected and interpreted by the Bluetooth technology that is currently incorporated into most modern mobile devices 134. The signal sent from the beacon 160 identifies this particular beacon 160 to an app running on the user's mobile device 134. The app can communicate with a remote server computer to identify the beacon 160 and thereby confirm that the device 134 is located within the retail store 102. In FIG. 1, at least two additional beacons 162 are located within the store 102 along with the beacon 160 located near the entrance 104. The additional beacons 162 allow the mobile device 134 to identify the customer's location within the store 102 more precisely. For example, it may be possible for the device 134 to use triangulation techniques to determine the customer location. In some embodiments, the beacons 160, 162 are not suitable for triangulation purposes. In these contexts, the beacons 160, 162 may have a very limited reception range (5 meters or less), meaning that numerous low-range beacons 160, 162 will be used to identify locations within the store 102. In this context, the device 134 would merely identify the beacon or beacons 160, 162 currently within range to identify the location of the device 134. Using this technology, a customer app would not only the user's location within the store 102, but could also access a store database to determine which physical products 110 are located close to the current location of the customer 130. The app could then present information or discount promotions to the customer 130 for those products 110.

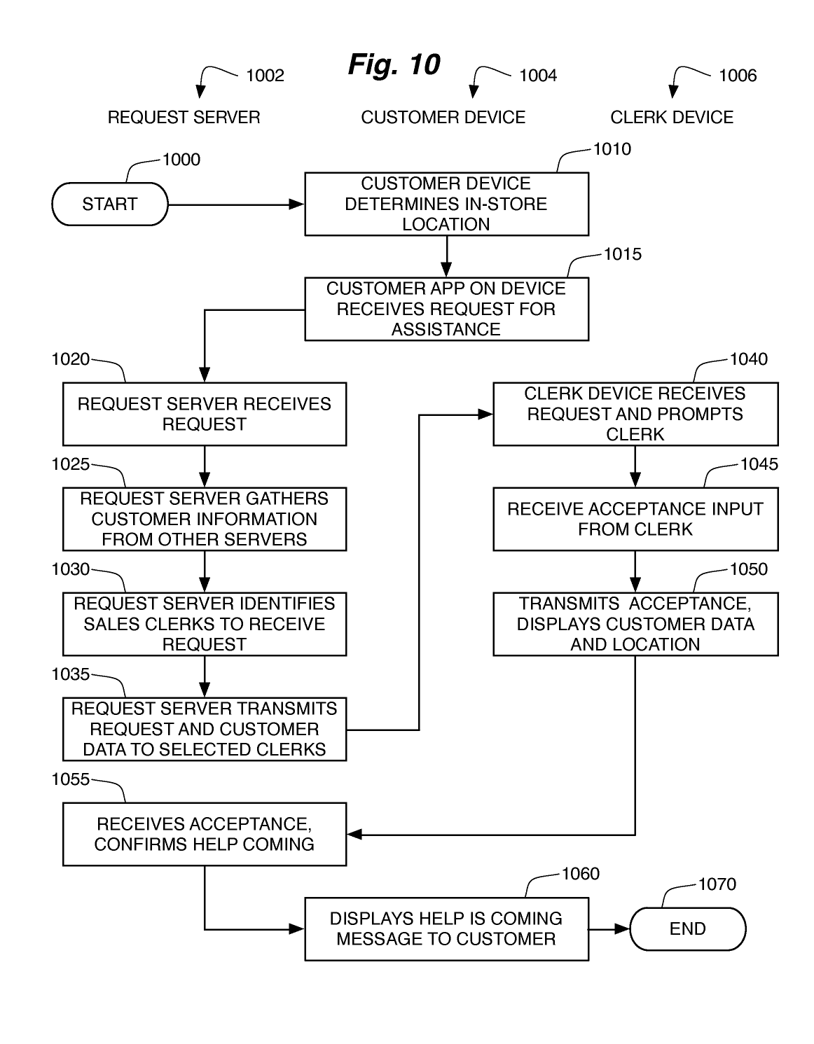

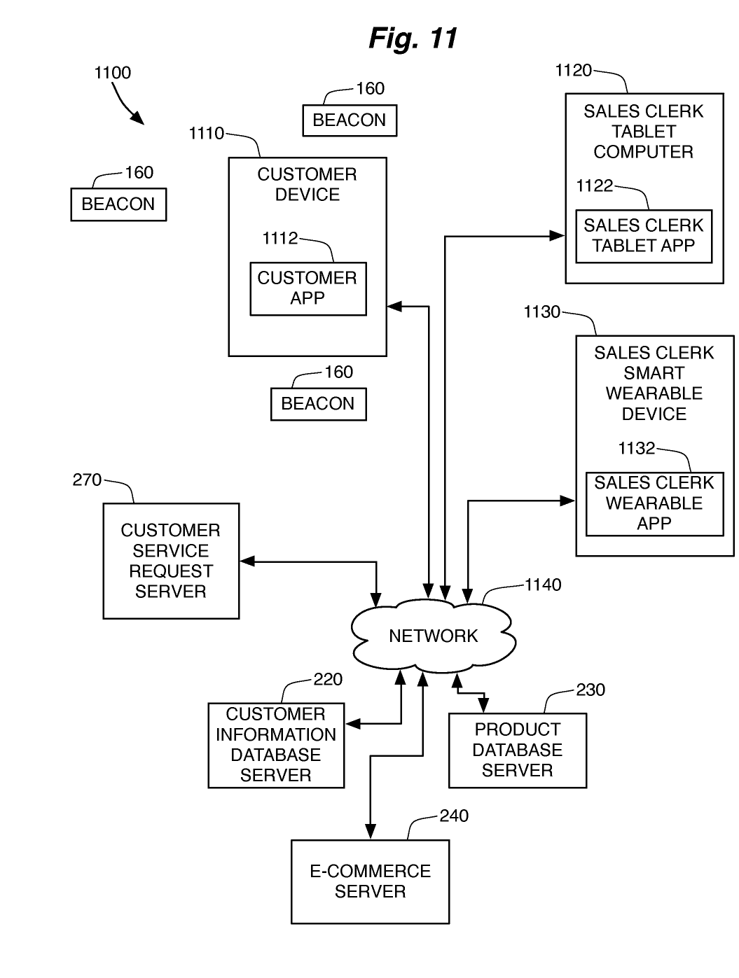

One benefit of populating a store 102 with sensors 152 and beacons 160, 162 is that it is possible to improve customer service provided by sales clerks and other employees 140 of the store 102. For instance, a customer 130 may enter the store 102 and open an app on their mobile device 134. The app can provide an interface allowing the customer 130 to request the assistance of a sales clerk 140. The app on the mobile device 134 can identify the store 102 and the customer's particular location within the store 102 to a central server, which can then send a service request to a sales clerk 140 via their mobile device 144. In most cases, the app running on the customer's device 134 will have knowledge of the customer's identity, which can be used to collect data about the customer from the store's own databases. Thus the service request received on device 144 can inform the sales clerk 140 of the customer's location within the store, their past buying habits in the physical store 102, their browsing habits at a website affiliated with the store 102, the amount of purchases made by the customer 130 at the store 102 and the website, and even any coupons or rewards that may have been earned by the customer 130 through the store's loyalty program. This process is described in more detail below in connection with FIGS. 10 and 11.

### Information System 200

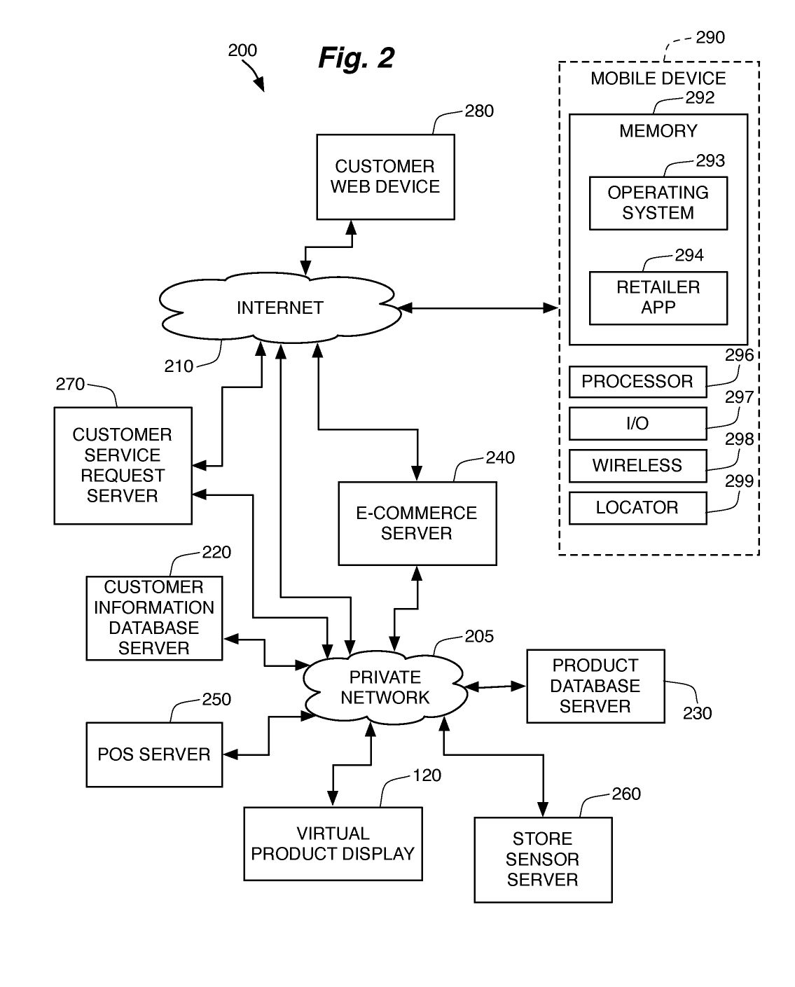

FIG. 2 shows an information system 200 that may be used in the retail store system 100. A private network 205 connects the virtual product display 120 with various servers operated by and for the retailer that operates the store 102. These servers include a customer information database server 220, a product database server 230, an e-commerce server 240, a point-of-sale server 250, a store sensor server 260, and an in-store customer service request server 270. The private network 205 may be a local area network, but in the preferred embodiment this network 205 allows servers 220, 230, 240, 250, 260, 270 and retail stores 102 to share data across the country and around the world. A public wide area network (such as the Internet 210) connects these devices 120, 220, 230, 240, 250, 260, 270 with third-party computing devices such as a customer web device 280, and mobile device 290. In FIG. 2, these networks 205, 210 are shown separately because each network performs a different logical function, even though the two networks 205, 210 may be merged into a single physical network in practice.

The customer database server 220 maintains a database of information about the customers who shop and purchase items at the retail store 102, who utilize the virtual product display 120, and who browse products and make purchases over the retailer's e-commerce server 240. In one embodiment, the customer database server 220 assigns each customer a unique identifier or “user ID” that is linked to personally-identifying information and the customer's purchase history. The customer information database server 220 may also contain information about loyalty programs run by the retailer. These programs may provide customers of the retailer with monetary awards, discounts, or unique shopping experiences.

The product database server 230 maintains a database of products sold by the retailer, whether through the physical display space 112 in the stores 102, the virtual product displays 120, or through the e-commerce server 240. The database 230 may include 3D rendered images of the products that are used by the virtual product display 120. The product database may also include a product name, manufacturer, category, description, price, local-store inventory info, online availability, physical store display location, and an identifier (“product ID”) for each product. The database maintained by server 230 is searchable by the mobile devices 290, customer web devices 280, and through the virtual product display 120 and its kiosk 124. Note that some of these searches can originate over the Internet 210, while other searches originate over the private network 205 maintained by the retailer.

The e-commerce server 240 provides a commerce platform for the retailer to sell goods over the Internet 210. The server 240 can be accessed from a web browser operating a customer's computing device 280, which could take the form of a personal computer, netbook, tablet, smart phone, or other device. In the preferred embodiment, the e-commerce server 240 also provides an interface to retailer-specific apps running on a mobile device 290. Relevant information obtained by the e-commerce server 240 can be shared with the customer information database server 220, allowing the system 200 to share information about a customer whether the customer is shopping for physical products 110 in the store 102, using the virtual product display 120, shopping with the web using device 280, or using a customer app on a mobile device 290.

The point of sale (POS) server 250 handles sales transactions for the point of sale terminals 106 in the retail store site 102. The POS server 250 can communicate sales transactions for goods and services sold at the retail store 102, and related customer information to the retailer's other servers 220, 230, 240, 260 over the private network 205.

The store sensor server 260 receives information from the various sensors 152 in the store 102 in order to create the customer follow-along system 150. Additional details about the store sensor server 260 are set forth below.

The in-store customer service request server 270 (or the “request server 270”) is responsible for initiating and tracking interactions between a store clerk 140 and a customer 130. As explained in more detail below, a customer 130 may use a retailer-specific customer app 294 on their mobile device 134 (290) to trigger a request for assistance. The app 294 on this device 134 (290) submits a request for assistance to the in-store customer service request server 270. The request will preferably include an identifier for the customer 130, an identifier for the store 102 that they are currently visiting (or location information from the device 134 so that store 102 can be determined), and the customer's location within the store 102. The in-store customer service request server 270 receives this request, gathers information about the customer from the customer information database server 220, and sends this information to an appropriate sales clerk 140 within store 102. The clerk 140 will receive this information on their mobile device 144 (290), triggering the clerk 140 to walk to the location of the customer 130 in order to render assistance.

FIG. 2 also shows additional details about the mobile devices 290 using the system 200, whether such devices 290 are used as a customer mobile device 134 or a sales clerk mobile device 144. Mobile devices 290 generally use specific operating systems 293 designed for such devices, such as iOS from Apple Inc. (Cupertino, Calif.) or ANDROID OS from Google Inc. (Menlo Park, Calif.). The operating systems 293 are stored on non-transitory memory 292 found on the device 290. The same memory 292 may also contain a retailer-specific app 294 that is designed specifically to interface with the rest of the system 200. The app 294 can take the form of a customer app that is used to browse products and make purchases using the e-commerce server 240, monitor the customer's status in a loyalty program maintained by the customer information database server 220, and navigate and request assistance at a physical store location 102. The customer app 294 may allow the customer 130 to self-identify by entering a unique identifier into the app 294. This identifier may be a loyalty program number for the customer 130, a credit card number, a phone number, an email address, a social media username, or other such unique identifier that uniquely identifies a particular customer 130 within the system 200. The mobile device 290 may store this identifier in the customer information database server 220 as well as in the physical memory 292 of device 134. The customer app 294 may allow the customer 130 to choose not to self-identify. Anonymous users could be given the ability to search and browse products for sale within app 294. However, far fewer app features would be available to customers 132 who do not self-identify. For example, self-identifying customers would able to make purchases via device 290, create “wish lists” or shopping lists, select communications preferences, write product reviews, receive personalized content, view purchase history, or interact with social media via app 294. Such benefits may not be available to customers who choose to remain anonymous.

The retailer app 294 may also take the form of a sales associate app. This app 294 is designed to assist customers 130, 132 in the store environment 102. The store associate app 294 is able to retrieve information from the product database server 230 to assist customers 130, 132 in product selection. The store associate app 294 can also retrieve information from the customer information database server 220 about a particular customer 130 when the store clerk 140 is assisting that customer 130.

Both the operating system 293 and the app 294 are comprised of programming instructions that control the functionality of a processor 296 found on the mobile device 290. The processor 296 can be a general purpose CPUs, such as those provided by Intel Corporation (Mountain View, Calif.) or Advanced Micro Devices, Inc. (Sunnyvale, Calif.), or can be a mobile specific processors, such as those designed by ARM Holdings (Cambridge, UK). As explained above, the clerk mobile device 144 may take the form of wearable eyewear such as Google Glass, which would still utilize the ANDROID operating system and an ARM Holdings designed processor.

The mobile device 290 further includes input/output devices 297 as is well known in the industry. This I/O elements 297 may include one or more physical buttons, a microphone, a speaker, a touch screen display, an optical head-mounted display, a touch pad, etc. The device 290 would also include wireless communication interface 298. This interface 298 can communicate with the Internet 210, the private network 205, or another mobile device 290 via one or more wireless protocols, such as Wi-Fi, cellular data transfer, Bluetooth, infrared, radio frequency, near-field communication (NFC) or other wireless protocols. The wireless interface 298 allows the device 290 to search the product database server 230 remotely through one or both of the network 205, 210. The device 290 may also send requests to the virtual product display 120.

Mobile device 290 also preferably includes a geographic location determination device (or “locator”) 299. The locator 299 may use global positioning system (GPS) tracking or other methods of determining a location of the device 290. For example, the device location could be determined by triangulation based on the known location of detected wireless transmitting devices. The prior art teaches how to locate a mobile device by triangulating the location of detected cellular phone towers, Wi-Fi hubs, and Bluetooth beacon transmitters 160, 162. The locator 299 in the mobile device 290 could use any of these known technologies. Alternatively, locator 299 could be omitted from the mobile device 290. In this embodiment, the system 200 would identify the location of the mobile device 290 by detecting the presence of wireless signals from wireless interfaces 298 at sensors 152 and analyzing this information at the store sensor server 260. For instance, mobile devices 290 frequently search for Wi-Fi networks automatically, allowing a Wi-Fi network within the retail store environment 102 to identify and locate a mobile device 290 even if the device 290 does not sign onto the Wi-Fi network. Similarly, some mobile devices 290 transmit Bluetooth signal that identify the device and can be detected by sensors 152 in the retail store 102. Other indoor location tracking technologies known in the prior art could be used to identify the exact location of the devices 134, 144 within a physical retail store environment. In some embodiments, the on-device locator 299 is used to supplement the information obtained by the sensors 152 in order to identify and locate both the customers 130, 132 and the store employees 140 within the retail store 102.

### Servers

FIG. 2 shows a variety of servers 220-270 that are operated by a retailer to create system 200. Each of these servers can be implemented on their own separate physical computer. Alternatively, each server could be implemented using a plurality of physical computers all operating together under common programming in order to effectively form a single computer server. In addition, the distinction between the individual servers 220-270 in FIG. 2 was primarily designed to disclose the separate functions that must be performed to implement system 200. It is well within the scope of the present invention to combine two or more of the servers 220-270 shown in FIG. 2 into a single physical computer.

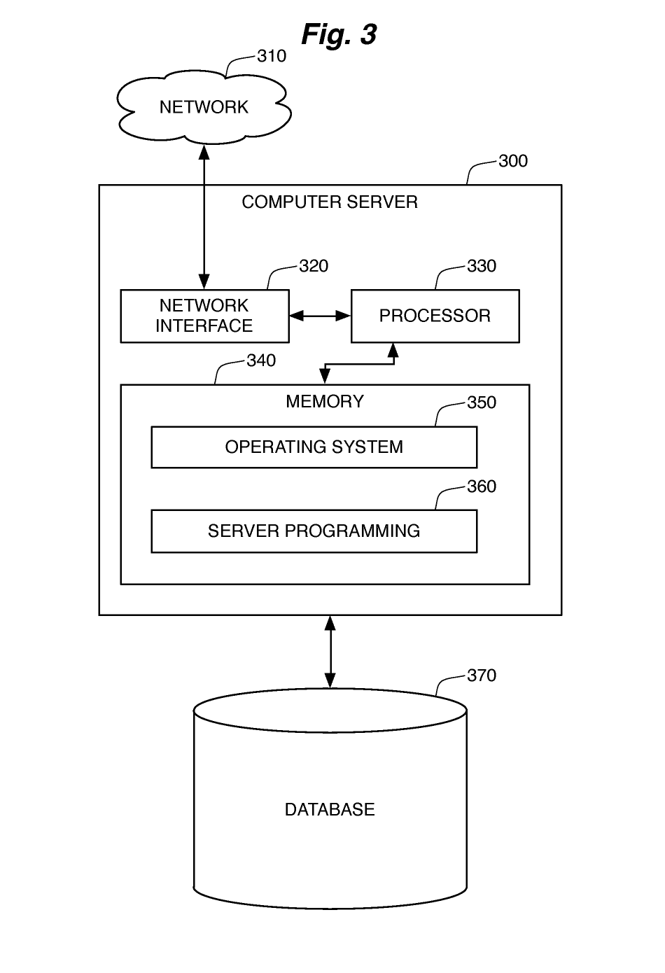

FIG. 3 shows the primary components of a physical computer 300 that could operate one or more servers 220-270 or form part of a server 220-270 with other physical computers. The computer 300 is designed to communicate with an external network 310 (such as private network 205 or the Internet 210). To communicate with this network 310, the computer 300 has a network interface 320. In the preferred embodiment, the network 310 is a TCP/IP network and the network interface 320 includes hardware and software components necessary to implement a TCP/IP protocol stack. Data communications with the network 310 are controlled and interpreted by a processor 330 utilizing programming stored in a tangible, non-transitory memory 340. The processor 330 may be a microprocessor manufactured by Intel Corporation of Santa Clara, Calif., or Advanced Micro Devices, Inc. of Sunnyvale, Calif.

The processor 330 is under the control of programming instructions 350, 360 stored in the memory 340 of the computer 300. The memory 340 preferably includes non-transitory, non-volatile memory such as a hard disk or flash memory to ensure that data and instructions are not lost when power is removed from the computer 300. To improve efficiency, the processor 330 may load software stored in non-volatile memory into faster, but volatile RAM. In the present disclosure, RAM and more permanent storage such as hard disk and flash memory devices are both referred to as memory 340. The memory 340 contains a general-purpose operating system 350, such as Windows from Microsoft Corp. (Redmond, Wash.), Linux (widely available from multiple sources under open source licenses), or Mac OS from Apple, Inc., as well as server programming 360 that controls the operation of the computer 300.

Data managed by the server computer 300 may be stored in local memory 340, or in an external database 370. The external database 370 may itself be managed and controlled by a separate computer, with the server computer 300 handling communications over the network 310 and the database computer 370 being responsible for handling and responding to database queries and maintaining the consistency and integrity of the data. The database 370 can be implemented as one or more relational database tables containing the data fields for each data element described herein. It is also possible to implement the databases as objects in an object-oriented database. The distinction made between the servers 220-270 and their related data in FIG. 2 are made for ease in understanding the data maintained and manipulated by the computerized system 200. It is well within the scope of the present invention to combine all of these databases together into a single database structure. Furthermore, it is possible to combine only a subset of the databases together, either within a single table or other database structure, or through the use of database relationships, associations, or object class definitions.

The database 370 utilized by the customer information database server 220 contains customer-related data. This database may include, for each customer, a user ID, personal information such as name and address, on-line shopping history, in-store shopping history, web-browsing history, in-store tracking data, user preferences, saved product lists, a payment method uniquely associated with the customer such as a credit card number or store charge account number, a shopping cart, registered mobile device(s) associated with the customer, loyalty program points and information, and customized content for that user, such as deals, coupons, recommended products, and other content customized based on the user's previous shopping history and purchase history.

The product database server 230 accesses a product related database 370 that may include, for each product sold by the retailer, 3D rendered images of the product, a product identifier, a product name, a product description, product location (such retail stores that have the product in stock, or event the exact location of the product within a particular retail store 102), a product manufacturer, and gestures that are recognized for the 3D images associated with the product. The product location data may indicate that the particular product is not available in a physical store, and only available through the e-commerce server 240 or through the virtual interactive display 120. Other information associated with products for sale would be included in product database as will be evident to one skilled in the art, including sales price, purchase price, available colors and sizes, related merchandise, etc.

### Store Sensor Server 260

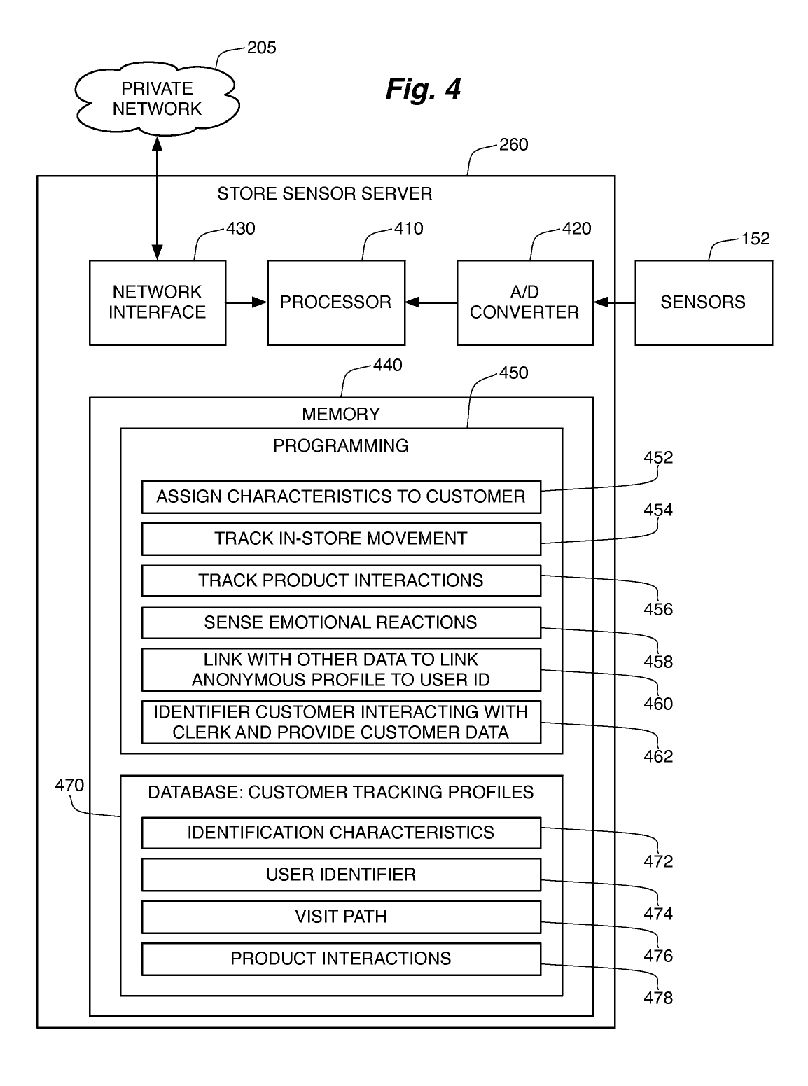

FIG. 4 is a schematic drawing showing the primary elements of a store sensor server 260. The store sensor server 260 is constructed like any other computer server 300, with a processor 410 for operating the server 260 and a network interface 430 to communicate with the private network 205. In addition, the store sensor server 260 is able to receive and analyze inputs from the various sensors 152 that may be found in a retail store environment 102. These sensors 152 are read by the store sensor server 260 through the use of one or more analog/digital converters 420 that receive data from the sensors 152 and convert the data into a digital format for analysis by the processor 410. In most environments, the A/D converters 420 will be external to the computer enclosure containing the processor 410 and memory 440 of the server 260, and will communicate with this enclosure via a digital communication path or bus, such as a USB bus. In most cases, the A/D converters 420 will be integrated into the sensors 152 themselves. In one embodiment, the sensors 152 communicate with the store sensor server 260 through a network, such as private network 205. Each sensor 152 may be equipped with a wireless (Wi-Fi) or wired network interface in order to establish a data connection with, and send sensor data to, the store sensor server 260. The store sensor server 260 also has a tangible memory 440 containing both programming 450 and data in the form of a customer tracking profiles database 470. As explained in connection with FIG. 3, this data 470 can be stored within the same memory as the programming 450, or in an external database system.

The programming 450 is responsible for ensuring that the processor 410 performs several important processes on the data received from the sensors 152. In particular, programming 452 instructs the processor 410 how to track a single customer 130 based on characteristics received from the sensors 152. The ability to track the customer 130 requires that the processor 410 not only detect the presence of the customer 130, but also assign unique parameters to that customer 130. These parameters allow the store sensor server to distinguish the customer 130 from other customers 132, recognize the customer 130 in the future, and compare the tracked customer 130 to customers that have been previously identified. As explained above, these characteristics may be physical characteristics of the customer 130, or digital data signals received from devices (such as device 134) carried by the customer 130. Once the characteristics are defined by programming 452, they can be compared to characteristics 472 of profiles that already exist in the database 470. If there is a match to an existing profile, the customer 130 identified by programming 452 will be associated with that existing profile in database 470. If no match can be made, a new profile will be created in database 470.

Programming 454 is responsible for instructing the processor 410 to track the customer 130 through the store 102, effectively creating a path for the customer 130 for that visit to the store 102. This path can be stored as data 476 in the database 470. Programming 456 causes the processor 410 to identify when the customer 130 is interacting with a product 110 in the store 102. Interaction may include touching a product, reading an information sheet about the product, or simply looking at the product for a period of time. In the preferred embodiment, the sensors 152 provide enough data about the customer's reaction to the product so that programming 458 can assign an emotional reaction to that interaction. The product interaction and the customer's reaction are then stored in the profile database as data 478.

Programming 460 serves to instruct the store sensor server 260 how to link the tracked movements of a customer 130 (which may be anonymous) to an identified customer in the customer database maintained by server 220. As explained elsewhere, this linking typically occurs when a user being tracked by sensors 152 identifies herself during a visit to the retail store 102, such as by making a purchase with a credit card, using a loyalty club member number, requesting services at, or delivery to, an address associated with the customer 130, or logging into the kiosk 124 or virtual display 120 using a customer identifier. When this happens, the time and location of this event is matched against the visit path of the profiles to identify which customer 130 being tracked has been identified. When this identification takes place, the user identifier 474 can be added to the customer tracking profile 470.

Finally, programming 462 is responsible for receiving a request from a store clerk 140 to identify a customer 130, 132 within the retail store 102. In one embodiment, the request for identification comes from the clerk device 144, which may take the form of a wearable smart device such as smart eyewear. The programming 462 is responsible for determining the location of the clerk 140 with the store 102, which can be accomplished using the store sensors 152 or the locator 291 within the clerk device 144. In most embodiments, the programming 462 is also responsible for determining the orientation of the clerk 140 (i.e., which direction the clerk is facing). This can be accomplished using orientation sensors (such as a compass) within the clerk device 144, which sends this information to the store sensor server 260 along with the request for customer identification. The location and orientation of the clerk 140 can be used to identify which customers 130, 132 are currently in the clerk's field of view based on the information in the customer tracking profiles database 470. If multiple customers 130, 132 are in the field of view, the store sensor server 260 may select the closest customer 132, or the customer 132 that is most centrally located within the field of view. Once the customer is identified, customer data from the tracking database 470 and the database maintained by customer database server 220 are selectively downloaded to the clerk device 144 to assist the clerk 140 in their interaction with the customer 132.

### Smart Wearable Mobile Devices 500

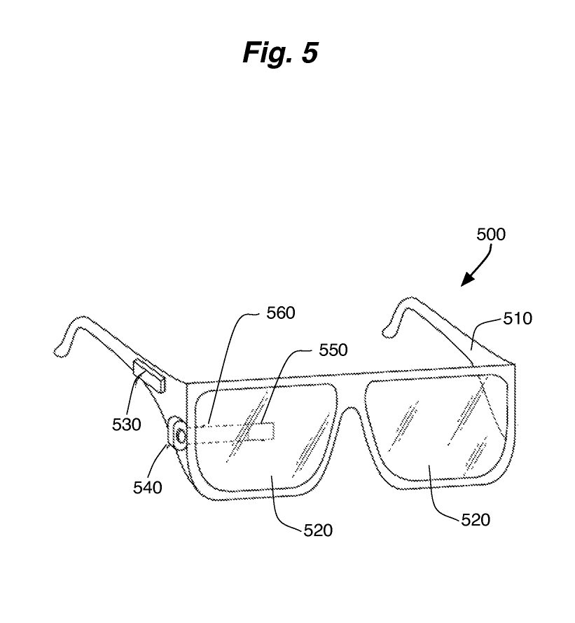

FIG. 5 shows a smart wearable mobile device 500 that may be utilized by a store clerk 140 as mobile device 144. In particular, FIG. 5 shows a proposed embodiment of Google Glass by Google Inc., as found in U.S. Patent Application Publication 2013/0044042. In this embodiment, a frame 510 holds two lens elements 520. An on-board computing system 530 handles processing for the device 500 and communicates with nearby computer networks, such as private network 205 or the Internet 210. A video camera 540 creates still and video images of what is seen by the wearer of the device 500, which can be stored locally in computing system 530 or transmitted to a remote computing device over the connected networks. A display 550 is also formed on one of the lens elements 520 of the device 500. The display 550 is controllable via the computing system 530 that is coupled to the display 550 by an optical waveguide 560. Google Glass has been made available in limited quantities for purchase from Google Inc. This commercially available embodiment is in the form of smart eyewear, but contains no lens elements 520 and therefore the frame is designed to hold only the computing system 530, the video camera 540, the display 550, and various interconnection circuitry 560.

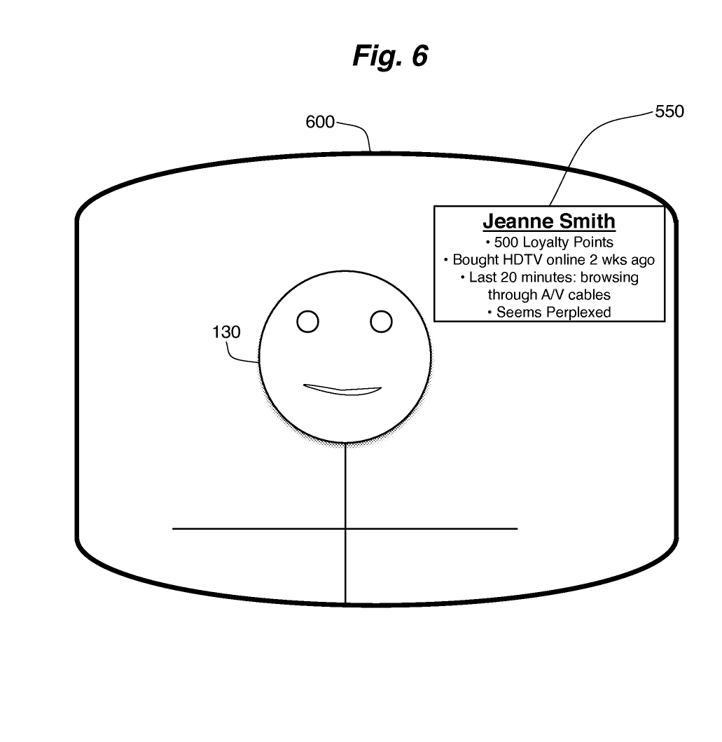

FIG. 6 shows an example view 600 through the wearable mobile device 500 that is worn by the store clerk 140 while looking at customer 130. The store clerk 140 is able to view a customer 130 through the device 500 and request identification and information about that customer 130. Based on the location of the clerk 140, the orientation of the clerk 140, and the current location of the customer 130, the store sensor server 260 will be able to identify the customer. Other identification techniques are described in connection with FIG. 15. When the customer 130 has been identified, information relevant to the customer is downloaded to the device 500. This information is shown displayed on display 550 in FIG. 10. In this example, the server 260 provides:
1) the customer's name,
2) the customer's status in the retailer's loyalty program (including available points to be redeemed),
3) recent, major on-line and in-store purchases,
4) the primary activity of the customer 130 that has been tracked during this store visit, and
5) the emotional reaction recorded during the primary tracked activity.
   In other embodiments, the server 260 could provide a customer photograph, and personalized product recommendations and offers for products and services based upon the customer's purchase and browsing history. Based on the information shown in display 550, the store clerk 140 will have a great deal of information with which to help the customer 130 even before the customer 130 has spoken to the clerk.

In other embodiments, the in-store customer service request server 270 will notify a clerk 140 that a customer 130 located elsewhere in the store needs assistance. In this case, the server 270 may provide the following information to the display 550:
1) the location of the customer within the store,
2) the customer's name,
3) primary activity tracked during this store visit, and
4) the emotional reaction recorded during the primary tracked activity.
   The clerk receiving this notification could then travel to the location of the customer needing assistance. The store sensor server 260 could continue tracking the location of the customer 130 and the clerk 140, provide the clerk 140 updates on where the customer 130 is located, and finally provide confirmation to the clerk 140 when they are addressing the customer 130 needing assistance.

In still other embodiments, the clerk could use the wearable device 500 to receive information about a particular product. To accomplish this, the device 500 could transmit information to the server 260 to identify a particular product. The camera 540 might, for instance, record a bar code or QR code on a product or product display and send this information to the server 260 for product identification. Similarly, image recognition on the server 260 could identify the product found in the image transmitted by the camera 540. Since the location and orientation of the device 500 can also be identified using the techniques described herein, the server 260 could compare this location and orientation information against a floor plan/planogram for the store to identify the item being viewed by the clerk. Once the product is identified, the server 260 could provide information about that product to the clerk through display 550. This information would be taken from the product database 500, and could include:
1) the product's name,
2) a description and a set of specifications for the product,
3) inventory for the product at the current store,
4) nearby store inventory for the product,
5) online availability for the product,
6) a review of the product made by the retailer's customers,
7) extended warranty pricing and coverage information,
8) upcoming deals on the product, and
9) personalized deals for the current (previously identified) customer.
   Method for Collecting Customer Data within Store

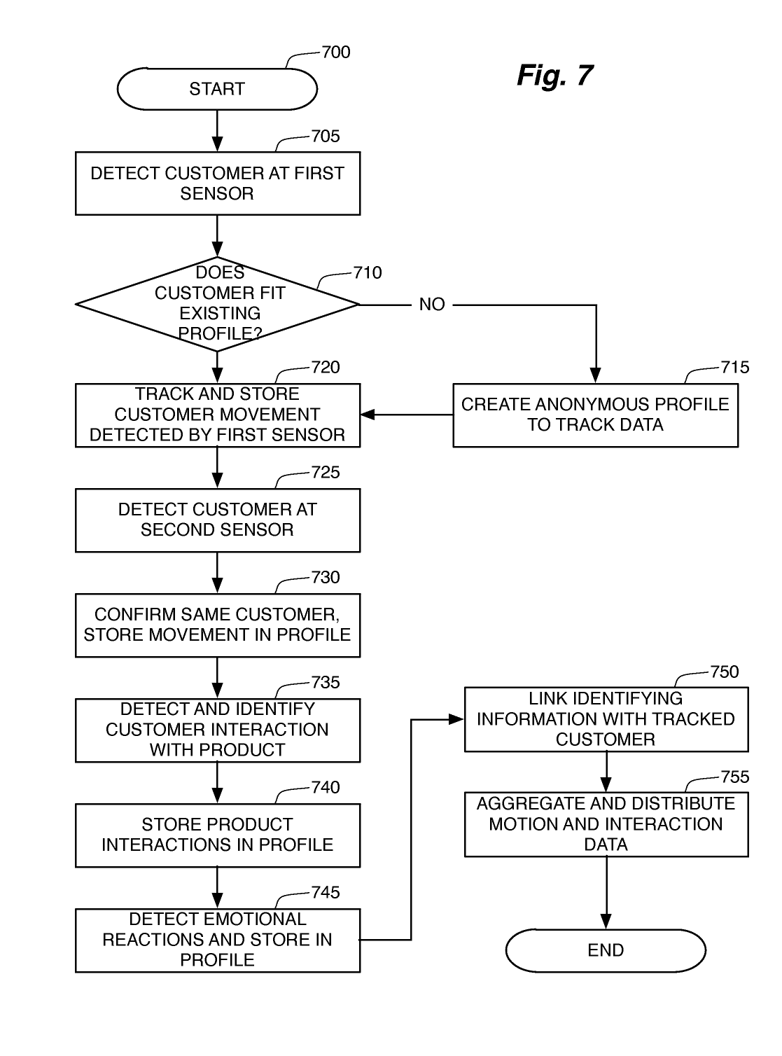

FIG. 7 shows a method 700 for collecting customer data analytics in a physical retail store using store sensors 152 and store sensor server 260. In step 705, a sensor 152 detects a customer 130 at a first location. The sensor 152 may be a motion sensor, video camera, or other type of sensor that can identify anatomical parameters for a customer 130. For example, a customer 130 may be recognized by a facial recognition, or by collecting a set of data related to the relative joint position and size of the customer 130's skeleton. Assuming that anatomical parameters are recognized that are sufficient to identify an individual, step 710 determines whether the detected parameters for the customer 130 matches an existing profile stored within the store sensor server 260. In one embodiment, the store sensor server 260 has access to all profiles that have been created by monitoring customers through the sensors 152 in store 102. In another embodiment, a retailer may have multiple store locations 102, and the store sensor server 260 has access to all profiles created in any of the store locations. As explained above, a profile contains sufficient anatomical parameters, as detected by the sensors 152, so as to be able to identify that customer 130 when they reenter the store for a second visit. If step 710 determines that the parameters detected in step 705 match an existing profile, that profile will be used to track the customer's movements and activities during this visit to the retail store 102. If step 710 does not match the customer 130 to an existing profile, a new profile is created at step 715. Since this customer 130 is not known in this event, this new profile is considered an anonymous profile.

The previous paragraph assumes that the sensors 152 identify customer 130 through the user of anatomical parameters that are related to a customer's body, such as facial or limb characteristics. Steps 705 and 710 can also be performed using sensors 152 that detect digital signatures or signatures from devices carried by the customer 130. For example, a customer's cellular phone may transmit signals containing a unique identifier, such as a Wi-Fi signal that emanates from a cellular phone when it attempts to connect to a Wi-Fi service. Technology to detect and identify customers using these signals is commercially available through Euclid of Palo Alto, Calif. Alternatively, the sensors 152 could include RFID readers that read RFID tags carried by an individual. The RFID tags may be embedded within loyalty cards that are provided by the retailer to its customers. The loyalty cards could also take the form of a smart card that responds to an inquiry by transmitting a unique identifier code. In these alternative embodiments, steps 705 and 710 are implemented by detecting and comparing the digital signatures (or other digital data) received from an item carried by the individual against the previously received data found in the profiles accessed by the store sensor server 260.

At step 700, the first sensor 152 tracks the customer's movement within the retail store 102 and then stores this movement in the profile being maintained for that customer 130. Some sensors may cover a relatively large area of the retail store 102, allowing a single sensor 152 to track the movement of customers within that area. Such sensors 152 will utilize algorithms that can distinguish between multiple customers that are found in the coverage area at the same time and separately track their movements. When a customer 130 moves out of the range of the first sensor 152, the customer may already be in range of, and be detected by, a second sensor 152, which occurs at step 705. In some embodiments, the customer 130 is not automatically recognized by the second sensor 152 as being the same customer 130 detected by the first sensor at step 705. In this embodiment, the second sensor 152 must collect anatomical parameters or digital signatures for that customer 130 and compare this data against existing profiles, as was done in step 710 for the first sensor. In other embodiments, the store sensor server 260 utilizes the tracking information from the first sensor to predict which tracking information on the second sensor is associated with the customer 130.

The anatomical parameters or digital signatures detected in steps 705 and 705 may be received by the sensors 152 as “snapshots.” For example, a first sensor 152 could record an individual's parameters just once, and a second sensor 152 could record the parameters once. Alternatively, the sensors 152 could continuously follow customer 130 as the customer 130 moves within the range of the sensor 152 and as the customer 130 moves between different sensors 152.

If the two sensors 152 separately collected and analyzed the parameters for the customer 130, step 730 compares these parameters at the store sensor server 260 to determine that the customer 130 was present at the locations covered by the first and second sensors 152.

In step 735, the sensors 152 recognize an interaction between the customer 130 and a product 110 at a given location. This could be as simple as recognizing that the customer 130 looked at a product 110 for a particular amount of time. The information collected could also be more detailed. For example, the sensors 152 could determine that the customer 130 sat down on a couch or opened the doors of a model refrigerator. The product 110 may be identified by image analysis using a video camera sensor 152. Alternatively, the product 110 could be displayed at a predetermined location with the store 102, in which case the system 100 would know which product 110 the customer 130 interacted with based on the known location of the product 110 and the customer 130. These recognized product interactions are then stored at step 740 in the customer's visit profile being maintained by the store sensor server 260.

In step 745, the customer's emotional reactions to the interaction with the product 110 may be detected. This detection process would use similar methods and sensors as was described in connection with the virtual display 120 in the incorporated parent applications, except that the emotional reactions would be determined based on data from the store sensors 152 instead of the virtual display sensors 246, and the analysis would be performed by the store sensor server 260 instead of the virtual display 120. The detected emotional reactions to the product would also be stored in the profile maintained by the store sensor server 260.

In step 750, the method 700 receives customer-identifying information that can be linked with the customer 130. Customer identifying information is information that explicitly identifies the customer, such as the customer's name, user identification number, address, or credit card account information. For example, the customer 130 could log into their on-line account with the retailer using the store kiosk 124, or could provide their name and address to a store clerk for the purpose of ordering products or services who then enters that information into a store computer system. Alternatively, the customer 130 could provide personally-identifying information at a virtual interactive product display 120. In one embodiment, if the customer chooses to purchase a product 110 at a POS 106, the customer 130 may be identified based on purchase information, such as a credit card number or loyalty rewards number. This information may be received by the store sensor server 260 through the private network 205 from the virtual product display 120, the e-commerce server 240, or the point-of-sale server 250.

The store sensor server 260 must be able to link the activity that generated the identifying information with the profile for the customer 130 currently being tracked by the sensors 152. To accomplish this, the device that originated the identifying information must be associated with a particular location in the retail store 102. Furthermore, the store sensor server 260 must be informed of the time at which the identifying information was received at that device. This time and location data can then be compared with the visit profiles maintained by the store sensor server 260. If, for example, only one customer 130 was tracked as interacting with the kiosk 124 or a particular POS terminal when the identifying information was received at that device, then the store sensor server 260 can confidently link that identifying information (specifically, the customer record containing that information in the customer database maintained by server 220) with the tracked profile for that customer 130. If that tracked profile was already linked to a customer record (which may occur on repeat visits of this customer 130), this link can be confirmed with the newly received identifying information at step 750. Conflicting information can be flagged for further analysis.

In step 755, the system repeats steps 705-750 for a plurality of individuals within the retail store 102, and then aggregates that interaction data. The interaction data may include sensor data showing where and when customers moved throughout the store 102, or which products 110 the customers were most likely to view or interact with. The data could include information about the number of individuals at a particular store location 102; information about individuals interacting with a virtual display 120; information about interactions with particular products 110; or information about interactions between identified store clerks 140 and identified customers 130. This aggregated information can be shared with executives of the retailer to guide the executives in making better decisions for the retailer, or can be shared with manufacturers to encourage improvements in product designs based upon the detected customer interactions with their products. The method 700 then ends.

### Method for Assisting Employee Customer Interactions

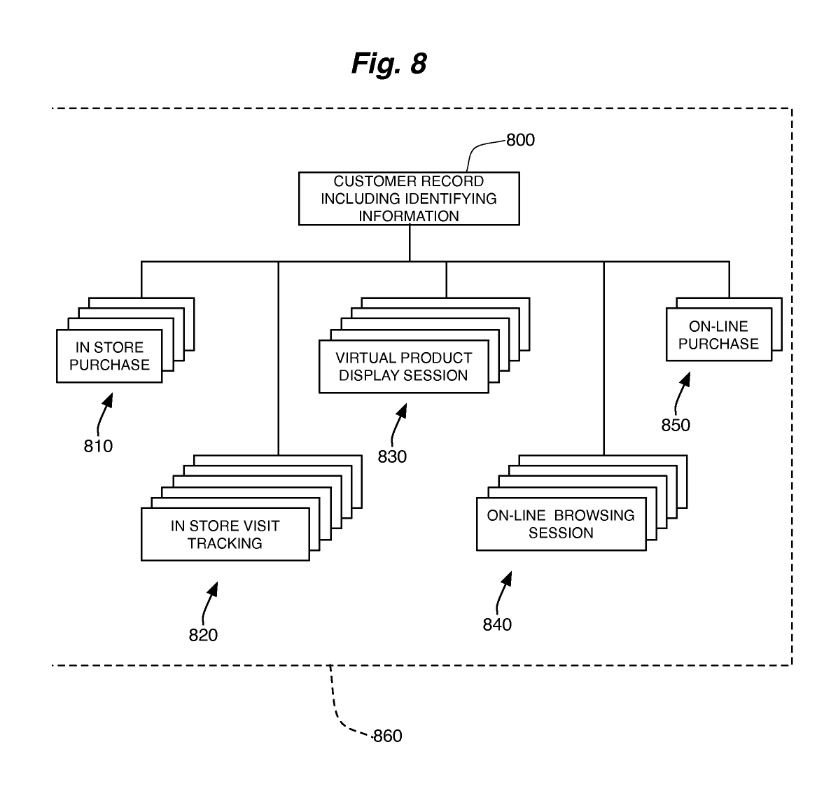

One benefit of the retailer system 100 is that a great deal of information about a customer is collected, which can then be used to greatly improve the customer's interactions with the retailer. FIG. 8 schematically illustrates some of this data. In particular, a customer record 800 from the customer database maintained by server 220 contains personal information about the user including preferences and payment methods. This basic customer data 800 is linked to in-store purchase records 810 that reflect in-store purchases that have been made by this customer. Linking purchase data accumulated by the POS server 250 to customer records can be accomplished in a variety of ways, including through the use of techniques described in U.S. Pat. No. 7,251,625 (issued Jul. 31, 2007) and U.S. Pat. No. 8,214,265 (issued Jul. 3, 2012). In addition, each visit by the customer to a physical retail store location can be identified by the store sensor server 260 and stored as data 820 in association with the client identifier. Each interaction 830 with the virtual product display 120 can also be tracked as described in the related applications. These data elements 800, 810, 820, and 830 can also be linked to browsing session data 840 and on-line purchase data 850 that is tracked by the e-commerce server 240. This creates a vast reservoir 860 of information about a customer's purchases and behaviors in the retailer's physical stores, e-commerce website, and virtual product displays.

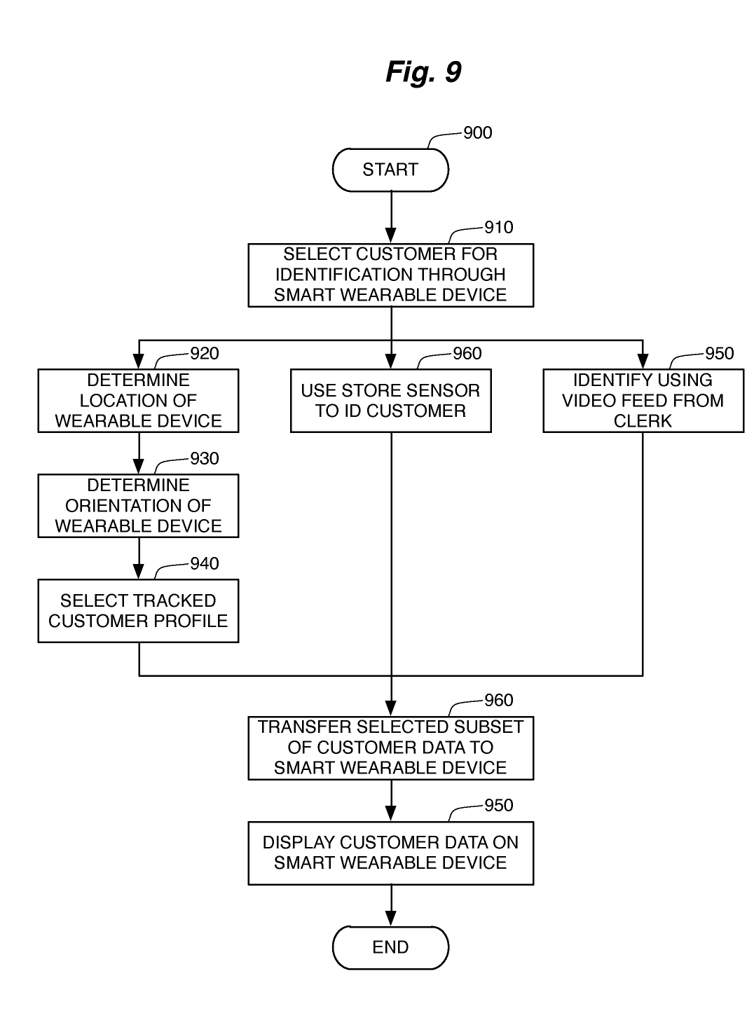

The flowcharts shown in FIGS. 9 and 10 describe methods that use this data 860 to improve the interaction between the customer 130 and the retail store clerk 140. Method 900 shown in FIG. 9 starts at step 910 with the clerk 140 requesting identification of a customer 130 who is currently visible to the clerk 140. This request is made through the clerk's mobile device 144. In one embodiment, the mobile device is a smart, wearable device such as smart eyewear 500. In another embodiment, the mobile device is a smart phone or tablet computer. When the request for identification is received, there are at least three separate techniques through which the customer can be identified.

In the first technique, a server (such as the store sensor server 260) identifies the location of the clerk 140 and mobile device 144 within the retail store 102 at step 920. This can be accomplished through the tracking mechanisms described above that use the store sensors 152. Alternatively, step 920 can be accomplished using a store sensor 152 that can immediately identify and locate the clerk 140 through a beacon or other signaling device carried by the clerk or embedded in the device 144, or by requesting location information from the locator 299 on the clerk's device 144. Next, at step 930, the server 260 determines the point of view or orientation of the clerk 140. This can be accomplished using a compass, gyroscope, or other orientation sensor found on the smart eyewear 500 or other device 144. Alternatively, the video signal from the eyewear's camera 540 (or other device camera) can be analyzed to determine the clerk's point of view. A third technique for accomplishing step 930 is to examine the information provided by store sensors 152, such as a video feed showing the clerk 140 and the orientation of the clerk's face, to determine the orientation of the clerk 140. Next, at step 940 the server 260 examines the tracked customer profiles to determine which customer is closest to, and in front of, the clerk 140. The selected customer 130 will be the customer associated with that tracked customer profile.

In the second customer identification technique, the store sensor server 260 uses a sensor 152 to directly identify the customer 130 standing closest to the clerk 140. For example, the sensors 152 may be able to immediately identify the location of the clerk by reading digital signals from the clerk's phone, smart eyewear 500, or other mobile device 144, and then look for the closest individual that also is emitting readable digital signals. The sensors 152 may then read those digital signals from a cell phone or other mobile device 134 carried by the customer 130, look up those digital parameters in a customer database, and then directly identify the customer 130 based on that lookup.

In the third customer identification technique, a video feed from the eyewear camera 540 is transmitted to a server, such as store sensor server 260. Alternatively, the eyewear camera 540 could transmit a still image to the server 260. The server 260 then analyzes the physical parameters of the customer 130 shown in that video feed or image, such as by using known facial recognition techniques, in order to identify the customer.

Alternative customer identification techniques could also be utilized, although these techniques are not explicitly shown in FIG. 9. For instance, the sales clerk could simply request that the user self-identify themselves, such as by providing their name, credit card number, or loyalty club membership number to the clerk. This information could be spoken into or other inputted into the clerk's mobile device 144 and transmitted to the server for identification purposes. In one embodiment, the clerk need only look at the card using the smart eyewear 500, allowing the eyewear camera 540 to image the card. The server would then extract the customer-identifying information directly from the image of that card.

Regardless of the identification technique used, the method continues at step 960 with the server gathering the data 860 available for that customer, choosing a subset of that data 860 for sharing with the clerk 140, and then downloading that subset to the smart eyewear 500 or other mobile device 144. This data 860 may include the customer's name, their status in a loyalty program, recent large purchases made (through any purchase mechanism), their primary in-store activity during this visit, and their last interpreted emotional reaction as sensed by the system 200. This data is then displayed to the clerk 140 through the smart eyewear 500 or the display on the mobile device 144, and the method ends.

Method 1000 shown in FIG. 10 shows a process by which a customer 130 can request assistance from a store clerk 140 at a retail store location. Method 1000 differs from method 900 in that this method 1000 requires that the customer 130 request assistance from a sales clerk 140 when they are inside the retail store 102. In contrast, method 900 allows a sales clerk 140 to receive information about any customer 130 to improve their interaction with the customer 130 whether or not the customer 130 requested assistance.

Method 1000 is accomplished using the system 1100 shown in FIG. 11, which includes a customer mobile device 1100 and one or more a sales clerk mobile devices 1120, 1130 communicating with servers 220, 230, 240, 270 over a computerized network 1140. This network 1140 can be a private network 205, the Internet 210 or other public network, or a combination of the two. Operating on the customer mobile device 1110 is a customer app 1112, which is a particular form of the retailer app 294 described above. The customer app 1112 not only provides a customer-facing user interface, but also is able to communicate with the e-commerce server 240 and the product database server 230 to make product inquiries and complete purchase transactions. This app 1112 is also able to request assistance from a sales clerk using the customer service request server 270, as described in more detailed below in connection with method 1000. FIG. 11 shows two different sales clerk devices 144, namely a tablet computer 1120 and a smart wearable device 1130. Operating on the sales clerk tablet computer 1120 is a sales clerk tablet app 1122, which provides a sales-clerk-facing user interface to the servers 220, 230, 240, 270. A similar app 1132 is operating on, or accessible to, the smart wearable device 1130.

Method 1000 is shown with various steps divided into three columns 1002, 1004, and 1006. Those method steps shown in the center column 1004 involve automated steps that take place on the customer device 1110. Those method steps shown in the left column 1002 take place on the customer service request server 270, while those steps in the right column 1006 take place on the sales clerk mobile device 1120, 1130. The method 1000 starts with the customer device 1110 identifying its location as being inside the retail store 102 at step 1010. Typically, this is accomplished using the customer app 1112 operating on the device 1110. This app is capable of monitoring the device's Bluetooth functionality in order to identify one or more beacons 160 placed within a retail environment 102. These beacons 160 can be sensed as soon as the device 1110 passes through the entrance 104 of the store 102. The beacons 160 can also be used to triangulate a relatively precise location for the customer 130 within the store 102. As the customer 130 moves around, the app 1112 will continue monitoring the beacons 160 to track the customer's location.

In one embodiment, the app 1112 will create a prompt on the display of the customer device 1110 as soon as an in-store beacon 160 is detected. This prompt may be created after the user affirmatively “checks-in” to the retail store location 102 using the capability of the app 1112. Alternatively, the app 1112 could be running on the device 1110 in the background and then supply the prompt after the beacon 160 is detected. The prompt might welcome the customer 130 to the store. In addition, the prompt could identify sale items or special promotions available to the customer. Because the app 1112 has access to the data on the servers 220, 230, 240, 270, these servers could utilize the past purchasing and browsing behavior of the customer 130 to create a special promotion for this customer 130 that is applicable only for this visit. For the purpose of method 1000, this prompt will also include an inquiry as to whether the customer would like assistance from a sales clerk 140.

When, at step 1015, the customer 130 indicates that they do desire assistance, the customer app 1112 will transmit the request for assistance to the customer service request server 270. This request for assistance will include an identifier for the customer 130, which will be known to the app 1112, as well as the customer's current location with the store 102 as determined by the app 1112. The request server 270 receives this request at step 1020, and then queries the customer information database server 220 to obtain more information about the customer 130. This information could include the customer's personal information such as name and address, on-line shopping history, in-store shopping history, web-browsing history, in-store tracking data, user preferences, saved product lists, a payment method uniquely associated with the customer such as a credit card number or store charge account number, the contents of their current shopping cart at the e-commerce server 240, loyalty program points and information, and customized deals, coupons, and recommended products that have been identified or created for that customer 130 based on their shopping history.

At step 1030, the request server 1002 will then identify sales clerks within the store 102 that are available to act upon the customer's request for assistance. To accomplish this, the server 270 might identify a set of sales clerks 140 that are currently on the sales floor 102, which could be determined either by a manual “check-in” process undertaken by the sales clerks using the sales clerk apps 1122, 1132, or by determining the physical location of the clerks 140 using either the sensors 152 or the beacons 160, 162 as read by the apps 1122, 1132. The apps 1122, 1132 may also provide a technique for each sales clerk to indicate whether they are already engaged in helping a customer. In this way, the server 270 can identify which clerks 140 are on the sales floor 102 and available to help this customer 130. The server then, at step 1035, transmits an assistance request to the sales clerk mobile devices 1120, 1130 asking the clerks to assist this customer 130. The server 270 may send these assistance requests to the sales clerks 140 one-at-a-time, selecting the “best” available clerk 140 for that customer 130. The best clerk 140 may be the clerk 140 that is in close physical proximity to the location of the customer 130, or it may be a clerk 140 that has not recently responded to an assistance request. Alternatively, the server 270 may send the assistance request to multiple sales clerks 140 at a time.

The assistance request sent by the server 270 in step 1035 may include the location of the customer received from the customer's app in step 1020 as well as the customer data gathered in step 1025. In other embodiments, this information will not be transmitted to the clerk device 1120, 1130 until after the clerk has accepted the assistance request, as described below. The customer location information that the server 270 sends to the clerk device 1120, 1130 may be the exact same location information received by the server from the customer's device 1110. In other circumstances, the customer device 1110 sends only sufficient information for the server 270 to derive the customer's location. For example, the customer device 1110 may only send a beacon identifier number that the device 1110 received from a nearby beacon 160, 162 in the retail store 102. In this case, the server 270 may process this data using known location information for the beacons 160, 162, and then provide this location data to the clerk mobile device 1120, 1130 in a more easy-to-understand format (such as “the customer is in aisle 6, at product location F”).

The mobile device 1120, 1130 of the sales clerk will then receive this assistance request at step 1040 and then notify the clerk 140 of the request through the user interface of the device 1120. For example, the tablet computer 1120 will display a prompt on the primary touchscreen of the tablet 1120, while the wearable device 1130 may display the prompt on display 550. In the preferred embodiment, the prompt will be accompanied by an audible indicator or a physical buzzing or movement of the device 1120, 1130. The sales clerk 140 may not be able to provide assistance at that time, so the device 1120, 1130 will be able to receive input from the clerk 140 declining the assistance request. If the clerk 140 can help at that time, the clerk 140 would input an acceptance of the assistance request at step 1045. At step 1050, the mobile device 1120, 1130 would transmit the acceptance back to the request server 270, and also provide relevant customer information to the sales clerk 140 on the user interface of the device 1120, 130. This customer information may include any of the information acquired by the request server 270 in step 1025, including the customer's name, photograph (if available), and current location in the store, as well as the customer's buying and browsing history, their status in a loyalty program, and any customer promotions or offers that are currently being presented to the customer 130. The clerk can then use their device 1120, 1130 to navigate to the customer 130 awaiting assistance.

In one embodiment, step 1050 will display the customer's name, photograph, and location on the screen of the device 1120, 1130 so that the sales clerk 140 can immediately identify the customer 130 needing assistance and their current location. This display may also include links to a list of recently purchased items by this customer 130, a list of recently viewed but un-purchased items (available through the e-commerce server 240, the store sensor server 260, or the virtual product displays 120), a list of recommended products for the customer 130 (determined by analyzing the recently purchased and recently viewed products and other information, such as demographics, age, and other family members, known about the customer 130), and a list of deals and offers that are currently available for that customer 130. The sales clerk 140 can view each of these lists simply by following the links provided on this display.

The request server 270 receives the acceptance notification from the sales clerk at step 1055. If the server 270 had sent a request to multiple sales clerks 140, the receipt of the confirmation at step 1055 would cause the server 270 to withdraw all of the requests sent to other clerks 140. If the server 270 instead is sending out requests one-at-a-time, then the server 270 must receive an unavailable input from the sales clerk device 1120, 1130 as soon as the clerk inputs this status into her device 1120, 1130. The server 270 would then send out an assistance request to the next sales clerk 140. In addition, the server 270 may cause a failure to respond by a sales clerk 140 within a set time period (such as 15 seconds) to be treated as an unavailable response. The server 270 may also send out a request to a subgroup (less than all) of the available sales clerks 140. As soon as one clerk 140 accepts, the requests to the other clerks 140 in the subgroup are canceled. If all the sales clerks 140 in the subgroup decline or do not respond, the request can be sent to a second subgroup.

At step 1055, the request server 1002 has received confirmation from the clerk device 1120, 1130 that the sales clerk 140 is willing to assist the customer. The server 270 then transmits a confirmation message to the customer device 1110 that a sales clerk 140 is coming to assist them. This confirmation message is then displayed on the customer device 1110 at step 1060. In one embodiment, the server 270 could provide information to the customer device 1110 about the sales clerk 140, such as providing a name and a photograph of the sales clerk 140 who is coming. The method then ends at step 1070.

In an alternate embodiment, the customer device 1110 does not determine its in-store location at step 1010, nor does the device 1110 send any location information to the server 270 in step 1015. Rather, the customer device 1110 merely sends to the server 270 a request for assistance along with a customer identifier (such as a customer ID number). The server 270 is then responsible for identifying the location of the customer 130 using the sensors 152 that form the customer follow-along system 150. As explained above, the store sensor server 260 can identify the location of the customer 130 (or track the customer's path) within the store 102, and associate that location with a particular customer identifier. The customer service request server 270 need only request from this server 260 the current location of the customer 130, and then transmit that to the clerk mobile device 1120, 1130 in step 1035.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method comprising:
a) receiving, at a server computer and from a customer mobile device, a request for assistance, the request for assistance including a customer identifier for a customer and a customer location, the customer location indicating a position of the customer mobile device within a physical retail store;
b) at the server computer, utilizing the customer identifier to gather customer data from a customer database;
c) at the server computer, identifying a clerk mobile device carried by an available sales clerk within the physical retail store;
d) at the server computer, transmitting an assistance request to the clerk mobile device;
e) at the server computer, transmitting the customer location and the customer data to the clerk mobile device for presentation on a display of the clerk mobile device.

2. The method of claim 1, wherein the customer location received from the customer mobile device as analyzed and transformed by the server before being transmitted to the clerk mobile device.

3. The method of claim 1, wherein the step of transmitting the assistance request to the clerk mobile device further comprises identifying a clerk mobile device address for the clerk mobile device and transmitting the assistance request to the clerk mobile device address.

4. The method of claim 3, wherein the clerk mobile device is a tablet computer.

5. The method of claim 1, further comprising:
f) at the server computer, receiving an acceptance of the assistance request from the clerk mobile device; and
g) at the server computer, transmitting a confirmation of help message to the customer mobile device indicating that the available sales clerk is to be expected.

6. The method of claim 5, wherein the confirmation of help message includes a photograph of the available sales clerk.

7. The method of claim 1, wherein the customer data presented on the display of the clerk mobile device comprises a photograph of the customer and a customer name.

8. The method of claim 1, wherein the customer data presented on the display of the clerk mobile device comprises past purchases made by the customer at a retailer associated with the physical retail store.

9. The method of claim 1, wherein the customer data presented on the display of the clerk mobile device comprises a status of the customer in a retailer loyalty program.

10. The method of claim 1, wherein the customer data presented on the display of the clerk mobile device comprises past browsing behavior of the customer at a website operated by a retailer associated with the physical retail store.

11. The method of claim 1, wherein the customer data presented on the display of the clerk mobile device comprises customized offers made to the customer by a retailer associated with the physical retail store.

12. The method of claim 1, wherein the customer data presented on the display of the clerk mobile device comprises recommended items available for purchase within the physical retail store, wherein the recommended items are recommended based on past customer purchase and browsing behavior.

13. The method of claim 1, wherein the customer location is derived from a beacon positioned within the physical retail store.

14. The method of claim 1, further comprising:
f) at the server computer, after transmitting the customer location to clerk mobile device, receiving customer location information from sensors at the physical retail store that detect a current location of the customer that is different from the customer location received from the customer mobile device;
g) at the server computer, transmitting a revised customer location based on the customer location information to the clerk mobile device for presentation on the display of the clerk mobile device.

15. The method of claim 14, wherein the sensors detect a MAC address from the customer mobile device to determine the customer location information.

16. A system comprising:
a server computer having a server processor, tangible, non-transitory server memory, and server programming on the server memory instructing the server processor;
a mobile device having a mobile device processor, a mobile device display, a tangible, non-transitory mobile device memory, and mobile device programming on the mobile device memory instructing the mobile device processor;
wherein the server programming programs the server processor to receive a request for assistance from a customer mobile device, the request for assistance including a customer identifier for a customer and a customer location, the customer location indicating a location for the customer mobile device within a physical retail store;
wherein the server programming further programs the server processor to use the customer identifier to gather customer data from a customer database
wherein the server programming further programs the server processor to transmit an assistance request, the customer location, and the customer data to the mobile device; and
wherein the mobile device programming programs the mobile device processor to present on the mobile device display the customer location and the customer data.

17. The system of claim 16, further comprising a beacon located in the physical retail store that transmits a unique beacon identifier; wherein the customer location received from the customer mobile device comprises the unique beacon identifier.

18. The system of claim 16, wherein the customer data comprises customer identifying information and information about past purchases made by the customer at a retailer associated with the physical retail store.

19. The system of claim 18, wherein the customer data further comprises a customized offer available to the customer based on past shopping behavior of the customer with the retailer.

20. A method comprising:
a) at a sensor found at a sensor location within a retail store, detecting identifying information concerning a customer;
b) at a server, receiving the identifying information from the sensor;
c) at the server, identifying a first customer record in a customer database based on the received identifying information;
d) at the server, receiving a request for customer assistance from a customer mobile device;
e) at the server, associating the first customer record with the request for assistance;
f) at the server computer, transmitting a request to assist the customer to a clerk mobile device, the request to assist the customer including the sensor location to indicate a current location for the customer.

21. The method of claim 20, wherein the sensor detects identifying information by detecting digital data transmitted from the customer mobile device.
